(19) United States
(12) Patent Application Publication
(10) Pub. No.: US 2026/0112325 A1
(43) Pub. Date: Apr. 23, 2026

(54) REWRITING DEVICE AND REWRITING METHOD FOR ELECTRONIC PAPER

(71) Applicant: SHARP KABUSHIKI KAISHA, Sakai City (JP)

(72) Inventor: KUNIAKI MATSUI, Sakai City (JP)

(21) Appl. No.: 19/357,543

(22) Filed: Oct. 14, 2025

(30) Foreign Application Priority Data
Oct. 17, 2024 (JP) 2024-182232

(51) Int. Cl. G09G 3/34

(52) U.S. Cl. CPC G09G 3/344; G09G 2320/0257; G09G 2330/02

(57) ABSTRACT

A rewriting device for an electronic paper that includes a rewriting circuit that rewrites the electronic paper, a power source connection circuit that connects the rewriting circuit and at least one power source, and a control processor that acquires power supply capability of the power source connected to the rewriting circuit and determines a size of a unit region when rewriting is performed according to the acquired power supply capability, wherein, when the determined unit region is smaller than an entire region of the electronic paper, the control processor rewrites the unit region, and then rewrites the entire region by sequentially shifting the unit region to an unrewritten position.

### INCORPORATION BY REFERENCE

This application is based upon and claims the benefit of priority from the corresponding Japanese Patent Application No. 2024-182232 filed on October 17, 2024, the entire contents of which are incorporated herein by reference.

### BACKGROUND

The disclosure relates to a rewriting device and a rewriting method for an electronic paper, and relates to a rewriting device and a rewriting method for rewriting the electronic paper by receiving power supplied from any of a plurality of types of power sources.

The electronic paper is a display device having an excellent characteristic of not consuming power during display. On the other hand, there is a problem specific to the electronic paper, which is one of factors that prevent the electronic paper from being widely used. For example, one of currently typical electronic paper systems is an electrophoretic system, but a time required for rewriting is longer as compared with a liquid crystal display device, an organic EL display device, or the like. Some of large-sized color electronic papers require a time on the order of 10 seconds to rewrite an entire region. Further, processing of the rewriting is accompanied by a phenomenon called flashing. The flashing refers to a state of an intermediate screen until a desired screen is displayed.

In order to make the flashing during the rewriting of the electronic paper less noticeable, a technique has been proposed in which a rewriting target region is divided into a plurality of sub-regions, rewriting start timing of each sub-region is set so that the flashing during the rewriting appears at different timings, and rewriting processing is performed per sub-region. The technique makes the flashing of each sub-region appear to be shifted, to create an impression that a page is scrolling or turning.

### SUMMARY

The disclosure provides a rewriting device for an electronic paper that includes a rewriting circuit that performs rewriting of the electronic paper, a power source connection circuit that connects the rewriting circuit and at least one power source to each other, and a control processor that acquires power supply capability of the power source connected to the rewriting circuit and determines a size of a unit region when the rewriting is performed according to the acquired power supply capability, wherein, when the determined unit region is smaller than an entire region of the electronic paper, the control processor rewrites the unit region, and then rewrites the entire region by sequentially shifting the unit region to an unrewritten position.

Further, from a different viewpoint, the disclosure provides a rewriting method for an electronic paper by a processor including (a) recognizing connection between a rewriting circuit that performs rewriting of the electronic paper and at least one power source, (b) acquiring power supply capability of the power source connected to the rewriting circuit, (c) determining a size of a unit region when the rewriting is performed according to the acquired power supply capability, and (d) rewriting the electronic paper per the unit region by using the rewriting circuit, wherein, step (d), when the determined unit region is smaller than an entire region of the electronic paper, rewrites the unit region, and then rewrites the entire region by sequentially shifting the unit region to an unrewritten position.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is an external perspective view illustrating an example of a display device in which an electronic paper according to the disclosure is used.

FIG. 2 is a rear view of the display device illustrated in FIG. 1.

FIG. 3 is a block diagram illustrating circuitry of the display device illustrated in FIG. 1 and devices that can be connected.

FIG. 4 is an explanatory diagram schematically illustrating a plurality of row drivers that drive row electrodes and a plurality of column drivers that drive column electrodes of the electronic paper according to the disclosure.

FIG. 5 is a first flowchart illustrating an example of rewriting processing per unit region, executed by a control processor illustrated in FIG. 3.

FIG. 6 is a second flowchart illustrating the example of the rewriting processing per unit region, executed by the control processor illustrated in FIG. 3.

### DETAILED DESCRIPTION

Hereinafter, the present disclosure will be described in further detail by using the drawings. Note that the following description is in all aspects illustrative and it should not be understood as limiting the present disclosure.

### First Embodiment

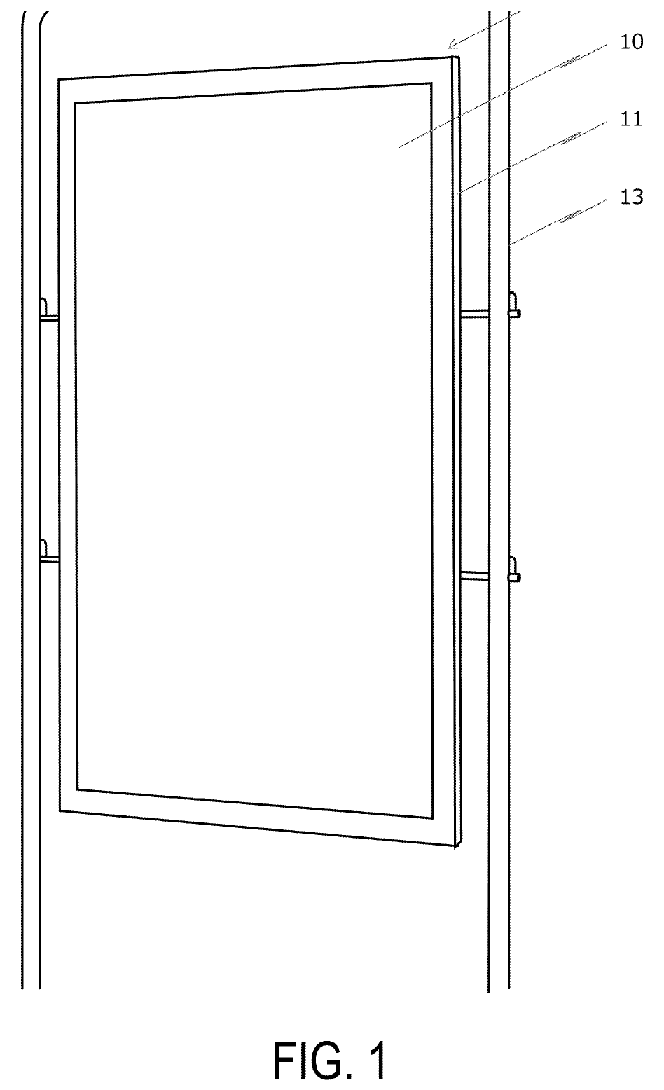

FIG. 1 is an external perspective view illustrating a front surface side of a display device as an example of a digital signage display (electronic signboard) in which an electronic paper is used in the disclosure. A display device 12 illustrated in FIG. 1 is an electronic paper 10 with a frame 11, and FIG. 1 illustrates an example in which the display device 12 is installed on a self-standing frame stand 13. Note that in FIG. 1, leg portions of the frame stand 13 are not illustrated. The display device 12 has a shape and a size suitable for applications such as a Point of Purchase (POP) advertisement, a guide plate, and the like. A size of the electronic paper 10 for these applications is preferably equal to or greater than 20 inches (corresponding to approximately A3 size paper in area) when expressed by a length of a diagonal line, similarly to a television or the like.

The display device 12 illustrated in FIG. 1 includes a built-in circuit for rewriting the electronic paper 10, further includes a plurality of types of connectors to each of which an external power source can be connected, and further includes a mounting portion to which a battery as a power source can be mounted.

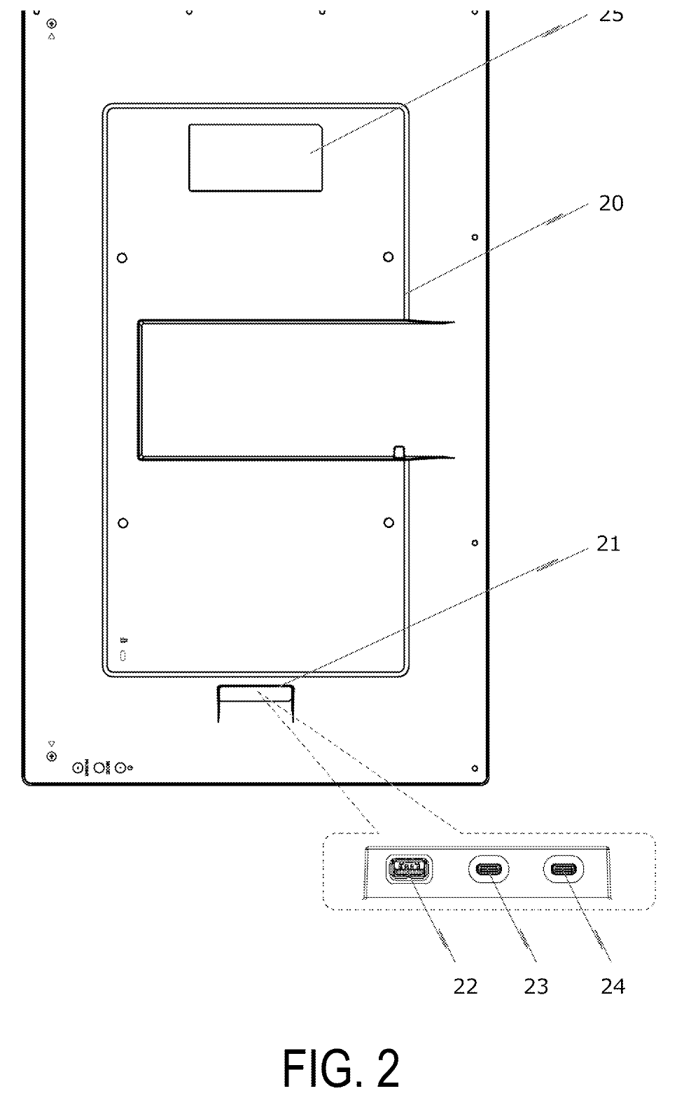

FIG. 2 is a rear view of the display device 12 illustrated in FIG. 1. As illustrated in FIG. 2, the display device 12 is formed with a circuit holder 20 that protrudes slightly at a central portion of a back surface side thereof. The circuit holder 20 holds a control circuit 31, a rewriting circuit 32, and a wireless communication module 36, which will be described below, and can further hold an optional battery 35. A protruding side surface of the circuit holder 20 is provided with a connector panel 21. At the connector panel 21, one Type-A connector 22 and two Type-C connectors 23 and 24 are disposed as connectors for USB connection. Additionally, a back surface of the circuit holder 20 is provided with a rectangular lid 25 that is opened when the battery 35 is mounted and held.

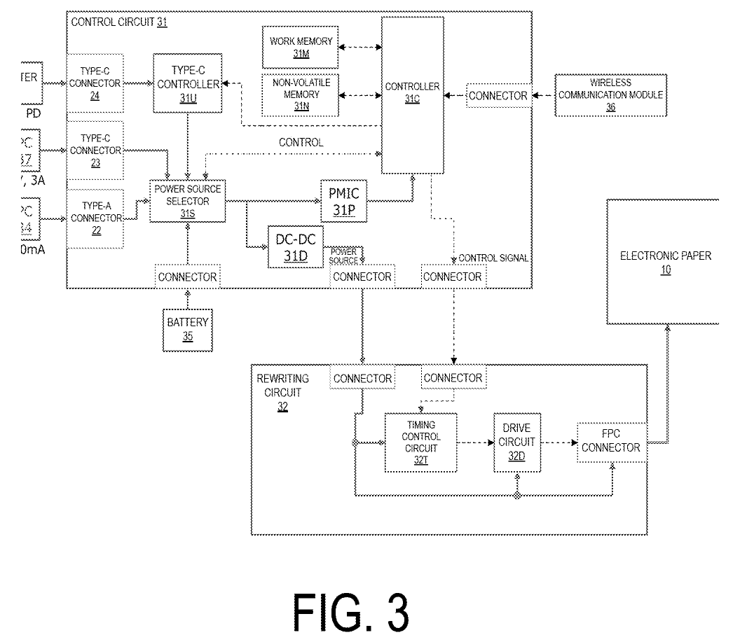

FIG. 3 is a block diagram illustrating the control circuit 31 and the rewriting circuit 32 held in the circuit holder 20, and devices that are to be connected or can be connected thereto. As illustrated in FIG. 3, the control circuit 31 can receive power of 5 V x 500 mA = 2.5 watts at maximum supplied from a device (PC 34 in the example of FIG. 3) connected to the Type-A connector 22. The power of 2.5 watts is an upper limit value of Type-A defined by the USB standards. Additionally, the control circuit 31 can receive power of 5 V x 3 A = 15 watts at maximum supplied from a device (PC 37 in the example of FIG. 3) connected to the Type-C connector 23. The power of 15 watts is an upper limit value of Type-C defined by the USB standards.

Furthermore, the control circuit 31 can receive power of 20 V x 5 A = 100 watts at maximum supplied from a device (AC adapter 33 in the example of FIG. 3) connected to the Type-C connector 24 that complies with the Power Delivery (PD) standards. The power of 100 watts is an upper limit value defined by the PD standards. However, in practice, a voltage value (which of 5 V, 9 V, 15 V, and 20 V is to be used) and an upper limit value of a current are determined by negotiation at the time of connection. Alternatively, the control circuit 31 can receive power supplied from the battery 35 when the battery 35 is attached. In this manner, a plurality of types of devices can be connected to the control circuit 31, and the control circuit 31 can operate by receiving power supplied from the connected devices. The power supplied from these devices is also supplied to the rewriting circuit 32 described below. The electronic paper 10 is connected to the rewriting circuit 32, and the power supplied to the rewriting circuit 32 is used to apply a voltage to electrodes formed so as to apply an electric field to microcapsules disposed on a display surface of the electronic paper 10, to perform the rewriting.

The control circuit 31 includes a control processor 31C, a work memory 31M, a non-volatile memory 31N, a power management element 31P, a power source selector 31S, a Type-C controller 31U, and a DC-DC converter 31D.

The control processor 31C controls the entire display device 12. The control processor 31C reads out and executes a control program stored in the non-volatile memory 31N, to execute various types of processing including the rewriting of the electronic paper 10. As the control processor 31C, a System on a Chip (SoC) can be applied. However, the disclosure is not limited thereto, and may be achieved by, for example, a Central Processing Unit (CPU) or the like. The control processor 31C may be configured by not limited to one circuit, but a plurality of circuits.

As the work memory 31M, for example, a DRAM or an SDRAM can be applied. The work memory 31M provides a storage area required when the control processor 31C executes the various types of processing including the rewriting of the electronic paper 10. As the non-volatile memory 31N, for example, a flash memory, a Solid State Disk (SSD), or the like can be applied. The non-volatile memory 31N stores a processing program of the control processor 31C, image data that the electronic paper 10 is caused to display, and the like. As the power management element 31P, for example, a Power Management IC (PMIC) can be applied. The power management element 31P not only supplies power to cause the control processor 31C to operate, but also performs a power source start-up sequence, power saving control, and the like.

The power source selector 31S is a circuit that selects from which of the Type-A connector 22, the Type-C connectors 23, 24, and the battery 35 to receive supplied power under the control of the control processor 31C. Connectors to which the Type-A connector 22, the Type-C connectors 23, 24, and the battery 35 are connected correspond to connectors in the disclosure. The power source selector 31S corresponds to a selection circuit in the disclosure. The power source selector 31S brings any of the connectors into a state of being connected to power lines of the control circuit 31 and the rewriting circuit 32 under the control of the control processor 31C. That is, the power source selector 31S brings any of the connectors into the state of being connected to the power lines of the control circuit 31 and the rewriting circuit 32 under the control of the control processor 31C, and the control circuit 31 and the rewriting circuit 32 receive power supplied from the device connected to the connector. The connectors corresponding to the connectors, the power source selector 31S, and the lines connecting the connectors and the power source selector 31S correspond to a power source connection circuit of the disclosure.

Note that the power source selector 31S may be configured to be capable of detecting, for the connector that is not selected as well, whether the device is connected to the connector and is in a state capable of receiving supplied power. However, the control processor 31C may be configured to directly detect whether the device is connected to each connector and is in the state of being capable of receiving supplied power. The power source selector 31S selects one of the connectors from which the control circuit 31 and the rewriting circuit 32 receive supplied power. The Type-C controller 31U is a circuit device that mainly performs negotiation that complies with the PD standards. When the device is connected to the Type-C connector 24, the Type-C controller 31U negotiates with the connected device. Then, upper limit values of supplied voltage and current to be received from the device are determined.

The DC-DC converter 31D converts a voltage of the power source supplied from the control circuit 31 to the rewriting circuit 32 into a voltage required by the rewriting circuit 32 and stabilizes the voltage. The control circuit 31 is connected to the rewriting circuit 32 via a connector. The rewriting circuit 32 is connected to the electronic paper 10 via a Flexible Printed Circuit (FPC) connector. In the electronic paper 10 of an active matrix type, a plurality of transparent row electrodes extending in parallel in a lateral direction and a plurality of transparent column electrodes extending in parallel in a longitudinal direction are formed on a front side of the display surface on which the microcapsules are aligned. Then, a transistor for applying a voltage to the microcapsule and a transparent electrode are formed at each intersection of the row electrodes and the column electrodes. These transparent electrodes correspond to pixels aligned in the lateral and longitudinal directions in a matrix. In a case of a color electronic paper, a color filter is disposed corresponding to each transparent electrode, and each transparent electrode corresponds to any one of primary colors constituting one pixel. When the row electrodes and the column electrodes are scanned to be driven, an electric field corresponding to a drive voltage is generated between each transparent electrode and an electrode formed on a back side with the microcapsule interposed therebetween. The electric field moves white and black pigments in the microcapsule to change a distribution of the white and black pigments in the display surface, and an image is displayed. As described above, while it is necessary to generate the electric field by applying the voltage to the row electrode and the column electrode in the rewriting, the DC-DC converter 31D stabilizes the voltage applied to the row electrode and the column electrode of the electronic paper 10 in the rewriting.

The rewriting circuit 32 includes a timing control circuit 32T and a drive circuit 32D. The timing control circuit 32T controls timing of a scanning signal applied to the row electrode and the column electrode of the electronic paper 10 in the rewriting. The drive circuit 32D includes a plurality of row drivers that drive the plurality of row electrodes extending in the lateral direction and a plurality of column drivers that drive the plurality of column electrodes extending in the longitudinal direction, based on the scanning signals generated by the timing control circuit 32T. According to this configuration, the pixels of the electronic paper aligned in the lateral and longitudinal directions in a matrix can be rewritten by the rewriting circuit including the column drivers and the row drivers.

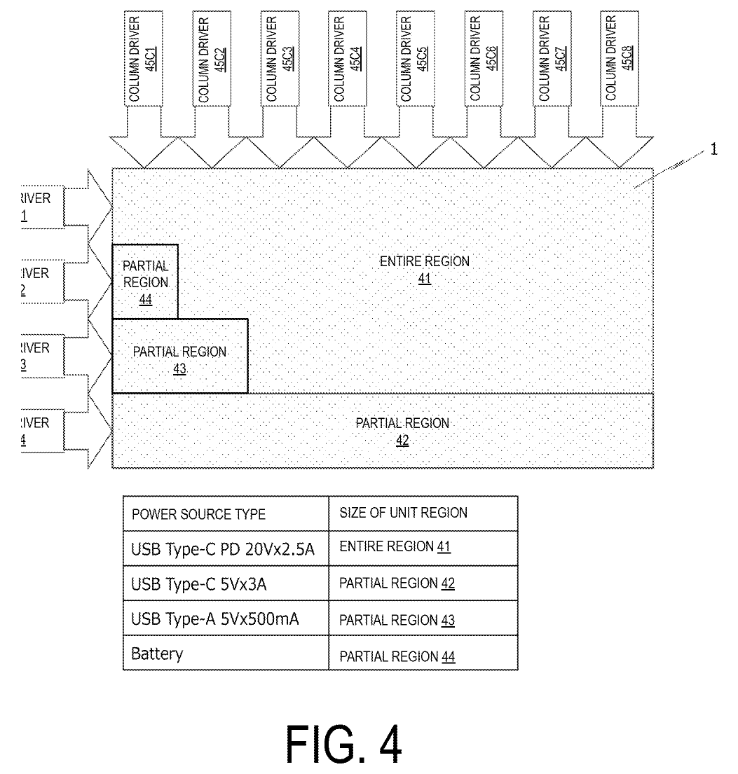

FIG. 4 is an explanatory diagram schematically illustrating the plurality of row drivers that drive the respective row electrodes extending in the lateral direction of the electronic paper 10 and the plurality of column drivers that drive the respective column electrodes extending in the longitudinal direction. In the example illustrated in FIG. 4, by using four row drivers 44R1 to 44R4 aligned in a short-side direction of the electronic paper 10, the respective row electrodes are driven, and by using eight column drivers 45C1 to 45C8 aligned in a long-side direction, the respective column electrodes are driven. Note that in the disclosure, as illustrated in FIG. 4, the long-side direction of the electronic paper 10 is the lateral direction, and the short-side direction is the longitudinal direction. FIGS. 1 and 2 illustrate a case in which the electronic paper 10 illustrated in FIG. 4 is rotated by 90 degrees so that a long side is set to face a vertical direction. Hereinafter, the longitudinal direction is referred to as the long-side direction, and the lateral direction is referred to as the short-side direction.

In FIG. 4, the number of row electrodes extending in the long-side direction and aligned in parallel in the short-side direction, in other words, the number of pixels aligned in the short-side direction is 1800, for example. Further, the number of column electrodes extending in the short-side direction and aligned in parallel in the long-side direction, in other words, the number of pixels aligned in the long-side direction is 3200, for example. According to the example, each of the four row drivers 44R1 to 44R4 drives one fourth of 1800, that is, 450 row electrodes, and each of the eight column drivers 45C1 to 45C8 drives one eighth of 3200, that is, 400 column electrodes. When a region that is driven by one row driver and one column driver is defined as one section, one section in the short-side direction is one fourth of a short side, and one section in the long-side direction is one eighth of the long side. Note that the number of row electrodes, the number of column electrodes, and the number of drivers that drive the row electrodes and the column electrodes described above are merely examples.

In the disclosure, a size of a unit region related to the rewriting is determined based on designing or experiments according to the power that can be supplied by the power source selected by the power source selector 31S, and is stored in the non-volatile memory 31N in advance. In this way, depending on which connector is selected by the power source selector 31S, power supply capability of the power source connected to the connector can be determined. As an example, FIG. 4 illustrates an example of a size of a unit region corresponding to the power supply capability of each power source. In the example illustrated in FIG. 4, a unit region corresponding to each of the Type-C connector 24 that complies with the PD standards and the Type-C connector 23 that does not comply with the PD standards is an entire region 41 of the electronic paper 10. That is, the unit region is a region having a size corresponding to four sections in the short-side direction and eight sections in the long-side direction. Note that in the example illustrated in FIG. 4, power required for rewriting the entire region 41 is 50 watts. In the case of the Type-C connector 24 that complies with the PD standards, a voltage of 20 V and a current of 2.5 A are supported when supplied power of 50 watts is to be received.

In the case of the Type-C connector 23 that does not comply with the PD standards, a voltage when receiving supplied power is 5 V, a maximum current is 3 A, and a size of the corresponding unit region is that of the partial region 42. The partial region 42 is a region having a size corresponding to one section in the short-side direction and eight sections in the long-side direction. In the case of the Type-A connector 22, a voltage when receiving supplied power is 5 V, a maximum current is 500 mA, and a size of the corresponding unit region is that of a partial region 43. The partial region 43 is a region having a size corresponding to one section in the short-side direction and four sections in the long-side direction. A size of the unit region corresponding to the battery 35 is that of a partial region 44. The partial region 44 is a region having a size corresponding to one section in the short-side direction and one section in the long-side direction. The control processor 31C determines the unit region related to the rewriting according to the power supply capability of the selected power source, and when the determined unit region is smaller than the entire region of the electronic paper 10, the unit region is sequentially shifted to rewrite the entire region. In this way, by making a region driven by at least one driver element correspond to a size in the lateral and longitudinal directions of the unit region, it is possible to sequentially perform the rewriting per unit region corresponding to the region driven by the at least one driver element.

Returning to the description of FIG. 3, the wireless communication module 36 is used, in the rewriting of the electronic paper 10, to perform the rewriting from an external PC, a smartphone, or the like via wireless communication. However, the rewriting of the electronic paper 10 can be performed by connecting a PC or a USB memory to the USB connector (the Type-A connector 22 or the Type-C connector 23), in addition to using wireless communication.

### Flowchart

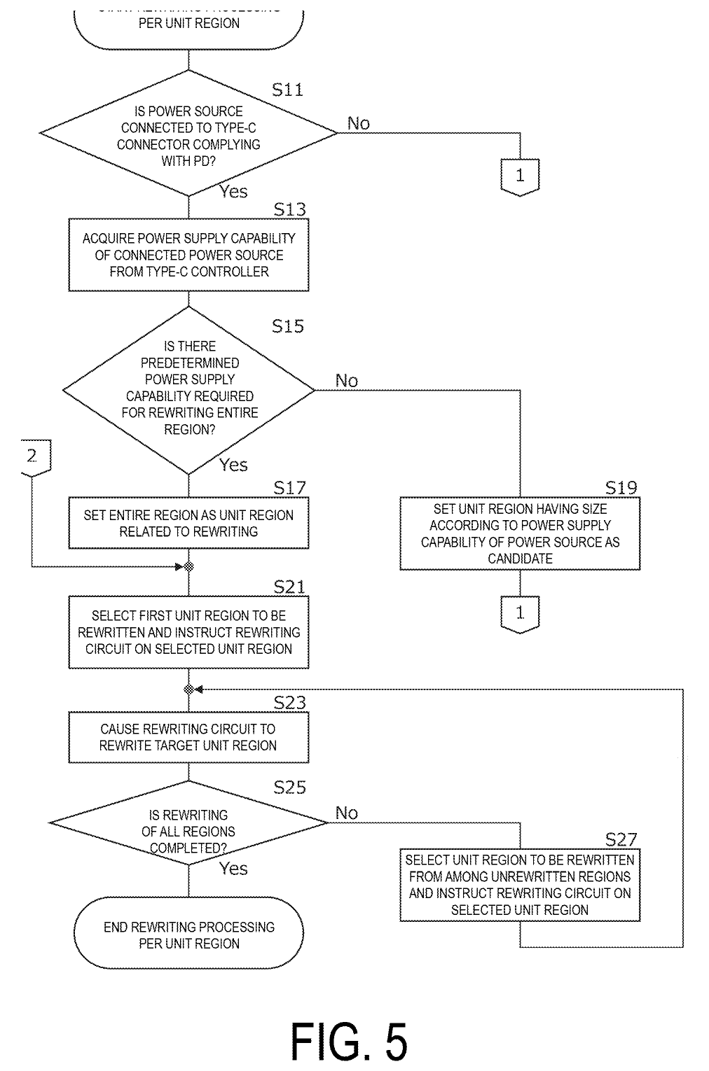

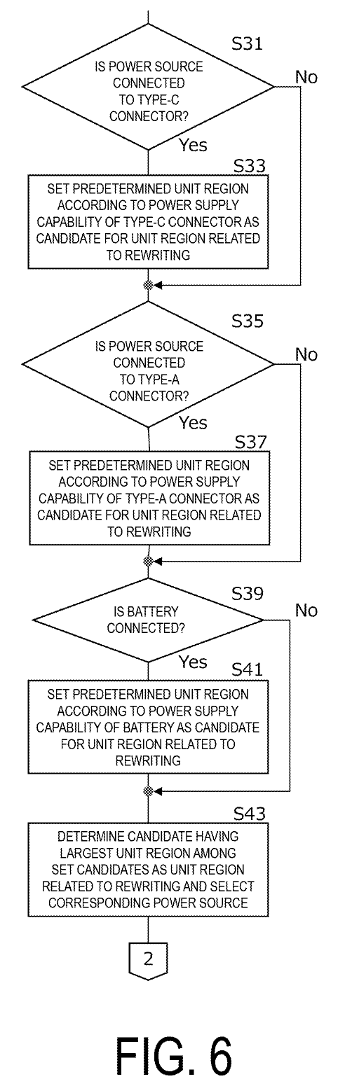

Next, a flow of the rewriting processing per unit region executed by the control processor 31C will be described with reference to a flowchart. FIGS. 5 and 6 are a flowchart illustrating an example of the rewriting processing per unit region executed by the control processor 31C. Note that FIGS. 5 and 6 focus on, among various types of processing executed by the control processor 31C, a determination of the unit region related to the rewriting and the rewriting processing according to the determination, and the other types of processing executed by the control processor 31C are omitted.

When power is supplied to the control circuit 31, the control processor 31C executes initializing processing (not illustrated in FIG. 5), and then checks which of the Type-A connector 22, the Type-C connectors 23, 24, and the connector of the battery 35 is in a state of being capable of supplying power via the power source selector 31S. In an aspect illustrated in the flowchart, the control processor 31C selects the power source that can supply the largest power among the power sources that are in the state of being capable of supplying power. To be specific, first, it is determined whether a device such as the AC adapter 33 is connected to the Type-C connector 24 that complies with the PD standards and is in the state of being capable of supplying power (step S11). When the state is determined in which power can be supplied from the Type-C connector 24 (Yes in step S11), power supply capability acquired by the Type-C controller 31U performing negotiation is acquired from the Type-C controller 31U (step S13). Then, it is determined whether power necessary for rewriting the entire region as the unit region related to the rewriting of the electronic paper 10 can be supplied (step S15). In this way, when a power source whose power supply capability can be changed by communication (negotiation) is connected to the connector, the power supply capability of the power source can be determined based on the communication (negotiation). Here, the power required for rewriting the entire region is determined by designing or experiments and is stored in the non-volatile memory 31N in advance. When it is determined in step S15 that the power necessary for rewriting the entire region of the electronic paper 10 can be supplied (Yes in step S15), the control processor 31C sets the entire region of the electronic paper 10 as the unit region related to the rewriting (step S17).

When the size of the unit region is determined, a position of the unit region to be rewritten first is selected according to the determined size of the unit region (step S21). When the unit region is the entire region of the electronic paper 10, the entire region is selected. When the unit region is smaller than the entire region, a first position is selected. Then, the control processor 31C instructs the rewriting circuit 32 on the position of the selected unit region. In this way, the control processor 31C designates the position of the unit region, and the designated position is rewritten by using the rewriting circuit 32, and thus the electronic paper 10 can be rewritten.

The control processor 31C causes the rewriting circuit 32 to rewrite the selected unit region (step S23). When the rewriting of the unit region is completed, the control processor 31C determines whether the rewriting of all regions of the electronic paper 10 is completed (step S25). That is, it is determined whether any unrewritten regions remain. When there are any unrewritten regions (No in step S25), the unit region to be rewritten next is selected from among the unrewritten regions, and a position thereof is instructed to the rewriting circuit 32 (step S27). Then, the processing is returned to step S23 described above, to cause the rewriting circuit 32 to rewrite the target unit region. In this way, the control processor 31C shifts the unit region to the unrewritten region and sequentially performs the rewriting until the rewriting of all the regions of the electronic paper 10 is completed. When the rewriting of all the regions of the electronic paper 10 is completed (Yes in step S25), the rewriting processing per unit region is ended.

On the other hand, when it is determined in the above described step S15 that the power necessary for rewriting the entire region of the electronic paper 10 cannot be supplied (No in step S15), the control processor 31C acquires the unit region related to the rewriting according to the acquired power supply capability and sets the unit region as a candidate (step S19). Here, the size of the unit region corresponding to the power supply capability is determined by designing or experiments and is stored in the non-volatile memory 31N in advance. Then, the processing proceeds to step S31 illustrated in FIG. 6. In addition, also when the state is determined in the above-described step S11 in which power cannot be supplied from the Type-C connector 24 that complies with the PD standards (No in step S11), the processing proceeds to step S31 illustrated in FIG. 6.

In step S31 illustrated in FIG. 6, the control processor 31C determines whether a device such as the PC 37 is in a state of being connected to the Type-C connector 23. When a state is determined in which power can be supplied from the Type-C connector 23 (Yes in step S31), the control processor 31C acquires the unit region related to the rewriting according to the power supply capability predetermined for the Type-C connector 23 and sets the unit region as a candidate (step S33). Then, the processing proceeds to step S35. Here, the power supply capability of the Type-C connector 23 that does not comply with the PD standards is determined as 5 V × 3 A = 15 W by the USB standards. The size of the unit region corresponding to the power supply capability is determined by designing or experiments and is stored in the non-volatile memory 31N in advance. When a state is determined in the above-described step S31 in which power cannot be supplied from the Type-C connector 23 (No in step S31), the processing proceeds to step S35.

In step S35, the control processor 31C determines whether a device such as the PC 34 is in a state of being connected to the Type-A connector 22. When a state is determined in which power can be supplied from the Type-A connector 22 (Yes in step S35), the control processor 31C acquires the unit region related to the rewriting according to the power supply capability predetermined for the Type-A connector 22 and sets the unit region as a candidate (step S37). Then, the processing proceeds to step S39. Here, the power supply capability of the Type-A connector 22 is determined as 5 V × 500 mA = 2.5 W by the USB standards. The size of the unit region corresponding to the power supply capability is determined by designing or experiments and is stored in the non-volatile memory 31N in advance. When the state is determined in the above-described step S35 in which power cannot be supplied from the Type-A connector 22 (No in step S35), the processing proceeds to step S39.

In step S39, the control processor 31C determines whether the battery 35 is in a state of being connected. When the battery 35 is in the state of being connected and capable of supplying power (Yes in step S39), the control processor 31C acquires the unit region related to the rewriting according to the power supply capability predetermined for the battery 35 and sets the unit region as a candidate (step S39). Then, the processing proceeds to step S43. Here, the power supply capability of the battery 35, and the size of the unit region corresponding to the power supply capability is determined by designing or experiments and is stored in the non-volatile memory 31N in advance. When the state is not determined in the above-described step S39 in which the battery 35 is connected and capable of supplying power (No in step S39), the processing proceeds to step S43.

In step S43, the control processor 31C determines, from among the set candidates, the candidate having the largest unit region as the unit region related to the rewriting, and instructs the power source selector 31S to select the power source corresponding to the determined unit region. Then, the processing returns to step S21 illustrated in FIG. 5, and a position of the unit region to be rewritten first is selected according to the size of the determined unit region. Thereafter, as illustrated in steps S23 to S27 of FIG. 5, until the rewriting of all the regions is completed, the unit region is shifted to the unrewritten region, and the rewriting is sequentially performed. The above is the flow of the rewriting processing per unit region executed by the control processor 31C.

Second Embodiment

In the first embodiment, the control processor 31C selects the power source corresponding to the largest unit region among the power sources in the state of being capable of supplying power, and sequentially performs the rewriting per unit region corresponding to the power supply capability of the power source. Unlike the first embodiment in which the control processor 31C selects the power source in this manner, a user may be allowed to select the power source. According to this embodiment, a plurality of the power sources that are connected via any of the connectors and are in the state of being capable of supplying power are switched by the user operating a changeover switch (not illustrated). For example, each time the user presses the changeover switch (not illustrated) provided at the display device 12, the control processor 31C causes the power source selector 31S to operate so as to sequentially switch selection of the plurality of power sources in the state of being capable of supplying power in response to the operation. In the rewriting, the control circuit 31 is in a state of receiving power supplied from the power source selected in this manner. The control processor 31C determines the unit region of the size corresponding to the selected power source, and sequentially performs the rewriting per unit region.

Third Embodiment

In the first embodiment, the power source selector 31S selects one of the connectors. That is, any one of the power sources is selected. However, the power source selector 31S may be configured to be capable of selecting a plurality of the power sources at the same time. According to this aspect, it is possible to perform the rewriting processing by receiving power supplied from the plurality of power sources at the same time. In this embodiment, the power source selector 31S is configured to be capable of setting a state of whether to receive power supplied from the device connected to the connector for each of the Type-A connector 22, the Type-C connectors 23, 24, and the battery 35. The control circuit 31 and the rewriting circuit 32 receive power supplied from at least one selected power source. However, the power sources that can be selected at the same time are limited to power sources of the same voltage. For example, since the power sources connected to the Type-A connector 22 and the Type-C connector 23 are the power sources of the same 5 V, power supplied from both of the power sources can be received at the same time. Regarding the Type-C connector 24 that complies with the PD standards, for example, a case will be considered in which a device is connected to the Type-C connector 24 in a state in which the power sources of 5 V are selected for the other Type-A connector 22 and Type-C connector 23. In this case, the device connected to the Type-C connector 24 can be set to supply a current of 3 A at maximum at a voltage of 5 V by negotiation. When the rewriting is performed in a state in which power supplied from the plurality of power sources is received, the control processor 31C determines the unit region having the size corresponding to total power supply capability of the plurality of selected power sources. Then, the rewriting is sequentially performed per determined unit region.

Fourth Embodiment

In the first to third embodiments, the size of the unit region related to the rewriting is determined by the control processor 31C according to the maximum power supply capability of the selected power source. In this embodiment, the control processor 31C applies the maximum power supply capability of the selected power source with a predetermined amount suppressed according to at least one of a time, a day, and a degree of magnitude of power consumed by other power loads, and determines the size of the unit region related to the rewriting according to the power supply capability. According to this aspect, when a power source situation varies depending on the time, the day, the degree of magnitude of the power consumed by the other power loads, and the like, the power supply capability of the power source according to the situation is determined, and the size of the unit region related to the rewriting of the electronic paper can be changed based on the determined power supply capability.

For example, it is assumed that the display device 12 receives power supplied from the AC adapter 33 connected to the Type-C connector 24. Then, it is assumed that the AC adapter 33 is connected to an AC outlet of a store where the display device 12 is installed. When the rewriting is performed during a period from 6 a.m. to 11:29 p.m. when people are passing, the control processor 31C sets the unit region related to the rewriting as the entire region. However, when the rewriting is performed during a period from 11:30 p.m. to 5:29 a.m. when people are not passing, the unit region may be determined as the partial region so that power is suppressed to 12.5 watts, that is one fourth of the power (for example, 50 watts) required to rewrite the entire region at once, and the rewriting may be sequentially performed per determined unit region. The period in which the unit region is the entire region and the period in which the unit region is the partial region may be set by the user using an application of a PC or the like, and the setting may be stored in the non-volatile memory 31N in advance via the wireless communication module 36 or any connector.

In addition, during business days or business hours of the store, the unit region may be determined so as to suppress the power to 25 watts, which is half of the power (for example, 50 watts) required to rewrite the entire region at once. This is because other electric power devices in the store use power during the business days or business hours of the store. The business days or business hours of the store may be set by the user using an application of a PC or the like, and the setting may be stored in the non-volatile memory 31N in advance via the wireless communication module 36 or any connector.

Alternatively, for example, the control processor 31C may communicate with a Home Energy Management System (HEMS) control device (not illustrated) via the wireless communication module 36. The HEMS control device manages power consumption of the entire store at which the display device 12 is installed. When receiving an instruction from the HEMS control device, the control processor 31C may determine the unit region so as to suppress instantaneous power required for the rewriting in accordance with the instruction. In this case, the unit region may be determined so that the power is suppressed to a ratio according to the instruction, for example, 10 watts, that is one fifth of the power (for example, 50 watts) required to rewrite the entire region at once, and the rewriting may be sequentially performed per determined unit region.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A rewriting device for an electronic paper, comprising:
a rewriting circuit that performs rewriting of the electronic paper;
a power source connection circuit that connects the rewriting circuit and at least one power source to each other; and
a control processor that acquires power supply capability of the power source connected to the rewriting circuit and determines a size of a unit region in a case where the rewriting is performed according to the acquired power supply capability, wherein,
in a case where the determined unit region is smaller than an entire region of the electronic paper, the control processor rewrites the unit region, and then rewrites the entire region by sequentially shifting the unit region to an unrewritten position 15:1.

2. The rewriting device according to claim 1, wherein
the power source connection circuit includes
a plurality of connectors corresponding in a one-to-one manner to a plurality of power sources allowed to be connected to the rewriting circuit, and
a selection circuit that selects which connector is to be connected to the rewriting circuit,
the control processor
includes a memory that stores in advance power supply capability of the respective plurality of power sources in association with the respective plurality of connectors corresponding in a one-to-one manner to the respective plurality of power sources, anddetermines the size of the unit region according to the power supply capability stored in the memory in association with a selected connector.

3. The rewriting device according to claim 2, wherein
the control processor communicates with a power source connected to the connector to acquire a range of power that the power source is allowed to supply, designates power to be supplied based on the acquired range of power supply capability, and determines the size of the unit region based on the designated power.

4. The rewriting device according to claim 3, wherein
the control processor designates the size of the unit region according to at least one of a time and a day at which the rewriting is performed and an instruction to reduce power consumption from outside.

5. The rewriting device according to claim 1, wherein
the electronic paper includes pixels aligned longitudinally and laterally in a matrix,
the rewriting circuit includes a column driver that drives a pixel line in a longitudinal direction in which the pixels are aligned in the longitudinal direction, and a row driver that drives a pixel line in a lateral direction in which the pixels are aligned in the lateral direction, and
the control processor controls the column driver to drive the pixel line corresponding to a longitudinal region of the unit region, and controls the row driver to drive the pixel line corresponding to a lateral region of the unit region, to rewrite the unit region.

6. The rewriting device according to claim 5, wherein
each of the column driver and the row driver includes a plurality of driver elements, and each of the plurality of driver elements drives the pixel line for one section of a plurality of sections into which the pixel line in one direction is divided, and
the size of the unit region corresponds to the pixel line for the one section.

7. The rewriting device according to claim 1 claim, wherein
the control processor designates a position of the unit region to be rewritten to the rewriting circuit, and
the rewriting circuit rewrites a pixel in the unit region at the designated position.

8. The rewriting device according to claim 1, wherein
the power source connection circuit is allowed to connect a plurality of power sources and the rewriting circuit to each other to receive power supplied from each of the plurality of power sources, and
the control processor determines the size of the unit region according to total power supply capability of the respective plurality of power sources connected.

9. A rewriting method for an electronic paper by a processor, comprising:(a) recognizing connection between a rewriting circuit that performs rewriting of the electronic paper and at least one power source;(b) acquiring power supply capability of the power source connected to the rewriting circuit;(c) determining a size of a unit region in a case where the rewriting is performed according to the acquired power supply capability; and(d) rewriting the electronic paper per the unit region by using the rewriting circuit, wherein,
step (d), in a case where the determined unit region is smaller than an entire region of the electronic paper, rewrites the unit region, and then rewrites the entire region by sequentially shifting the unit region to an unrewritten position.
